(19) United States
(12) Patent Application Publication
(10) Pub. No.: US 2006/0177559 A1
(43) Pub. Date: Aug. 10, 2006

(54) Stable beverage compositions containing tea polyphenols, flavonoids or catechins and methods

(75) Inventors: Barry Gosselin, Danbury, CT (US); Michael Gonley, Danbury, CT (US)

Correspondence Address: PEPSICO, INC.;c/o GOODWIN PROCTER LLP, EXCHANGE PLACE, BOSTON, MA, 02109, US

(73) Assignee: PepsiCo, Inc., Purchase, NY (US)

(21) Appl. No.: 11/307,060

(22) Filed: Jan. 20, 2006

Related U.S. Application Data
(60) Provisional application No. 60/650,199, filed on Feb. 4, 2005.

(51) Int. Cl. A23F 3/00

(52) U.S. Cl. 426/597

(57) ABSTRACT

Ready-to-drink color and turbidity stable beverage compositions are provided. The beverage compositions contain from about 100 to about 2,700 milligrams per liter by total weight of the beverage composition of a tea material selected from the group consisting of tea solids, tea polyphenols, tea flavonoids, tea catechins and combinations thereof. The composition contains water, a total of no more than from about 0 to 100 milligrams per liter divalent cations and a turbidity of less than about 50 NTU and even less than 20 NTU for compositions containing 900 mg/l of tea solids. Preferably, the tea material contains less than about 450 milligrams divalent cations per 100 grams of the tea material. The beverage compositions of the invention are color and turbidity stable when packaged and stored under normal conditions.

### FIELD OF THE INVENTION

The present invention relates to beverages. More particularly, the present invention relates to color and turbidity stable ready-to-drink beverages and methods of making them.

### BACKGROUND OF THE INVENTION

There are numerous ready-to-drink (RTD) beverages on the market. Recently, there has been an increased awareness of the desirability of consuming tea polyphenols, tea flavonoids and catechins. It is a straightforward process for a consumer to brew tea and consume it immediately. However, making tea beverages and beverages containing, for example, tea polyphenols, flavonoids and/or catechins poses problems. For example, such a product typically becomes turbid and even brown or muddy in appearance. In addition, a precipitate may also form. Generally, consumers do not find such properties to be desirable.

There are numerous ready-to-drink (RTD) beverages on the market. Recently, there has been an increased awareness of the desirability of consuming tea polyphenols, tea flavonoids and catechins. It is a straightforward process for a consumer to brew tea and consume it immediately. However, making tea beverages and beverages containing, for example, tea polyphenols, flavonoids and/or catechins poses problems. For example, such a product typically becomes turbid and even brown or muddy in appearance. In addition, a precipitate may also form. Generally, consumers do not find such properties to be desirable.

A need exists for beverage compositions containing tea and/or tea polyphenols, flavonoids and/or catechins that are stable and can be packaged as a ready-to-drink beverage and stored for long periods of time without significant detrimental changes to color, turbidity and other properties.

### SUMMARY OF THE INVENTION

In accordance with one aspect of the present invention, a stable beverage composition is provided. The beverage composition is suitable for use as a ready-to-drink beverage that can be packaged in a suitable container and stored for extended periods of time without significant deleterious effects on stability, including appearance and turbidity.

A beverage composition in accordance with the present invention includes from about 100 to 2,700 milligrams per liter by total weight of the beverage composition of a tea material selected from tea solids, tea polyphenols, tea flavonoids, tea catechins and combinations thereof. In addition, the beverage may optionally include at least one sweetener selected from nutritive, natural and artificial sweeteners and combinations thereof, water and no more than a total of from about 0 to about 100 milligrams per liter divalent cations in the beverage composition, resulting in a beverage having a turbidity of less than about 50 Nephelometric Turbidity Units (NTU). Preferably the turbidity is in the range of about 10 to about 40 NTU or less, and most preferably, in the range of about 10 to about 20 NTU. The compositions exhibit such low turbidity for extended periods of time after packaging, such as after about 180 days at 70° F. The tea material may be from green tea, black tea or combinations thereof.

In accordance with another aspect of the present invention, the tea material that is utilized in the beverage composition of the invention contains less than about 450 milligrams divalent cations per 100 grams of the tea material.

The beverage composition may also include a chelating agent present in a sufficient amount to bind the divalent cations present in the beverage composition. Suitable chelating agents are known in the art and include, for example, ethylenediaminetetraacetic acid and salts thereof, polyphosphates and sodium or potassium citrates.

The water used in the beverage composition in accordance with the invention should have a hardness of from about 0 to about 50 milligrams per liter measured as CaCO₃. The total hardness in the beverage measured as CaCO₃ is preferably about 25 milligrams per liter.

In accordance with another aspect of the invention, the beverage composition may contain green tea catechins present in an amount of from about 10 to about 2,000 milligrams per liter. The beverage may also include green tea flavonoids present in an amount of from about 10 to about 2,000 milligrams per liter, green tea polyphenols present in an amount of from about 10 to about 2,700 milligrams per liter.

Preferably, the pH of the beverage composition will be adjusted by the addition of a suitable acid so that the pH is in the range of from about 2.5 to about 6.5. A preferred pH range is from about 3.0 to about 5.0. Any suitable acid can be used to adjust the pH of the beverage in accordance with the invention. Typical acids include citric, phosphoric, ascorbic, malic and combinations thereof.

Turbidity is an important aspect of a beverage. Low turbidity is usually desirable in a tea beverage and in a ready-to-drink beverage. Beverages in accordance with the present invention will typically have a turbidity of less than about 50 NTU and preferably less than about 40 and most preferably less than about 20 NTU, even after storage of the beverage composition in accordance with the invention after packaging or bottling and storage for 180 days at 70° F. the beverage.

Other components may be added to the beverage composition in accordance with the invention as desired, provided that the additive materials do not adversely affect the composition and have zero or a relatively low concentration of divalent cations whether as a salt or as a byproduct so that less than 100 milligrams per liter of divalent cations are present in the final beverage composition. Consequently, in order to not exceed that level it is important to carefully select formulating ingredients that have zero or a very low level of divalent cations. Consequently, it is important to utilize ingredients that have a high purity. Examples of additional ingredients that may be added in accordance with the invention include but are not limited to: sodium and/or potassium benzoate, potassium sorbate and/or other preservatives;

Gums, pectins and/or other thickeners;

Citric acid, ascorbic acid, phosphoric acid, malic acid and/or other organic acids;

Sodium citrate, potassium citrate, polyphosphates and/or other buffering components;

Caramel, natural and/or artificial colors;

Flavors, extracts and emulsions;

Nutritive sweeteners, natural sweeteners and/or artificial sweeteners.

In accordance with another aspect of the present invention, a method of making a color and turbidity stable beverage composition that contains tea solids is provided. The method includes brewing a tea solution having tea solids and thereafter removing divalent cations from the brewed tea solution to form a resulting solution having a divalent cation level of less than about 450 milligrams divalent cation per 100 grams of tea solids. Thereafter, a beverage is formed from the resulting solution, the beverage having a total of no more than from about 0 to about 100 milligrams per liter divalent cations and comprises from about 100 milligrams per liter to about 2,700 milligrams per liter tea solids.

In accordance with another aspect of the method, the tea solution is a green tea solution and the removing of the divalent cations comprises treating the tea solution to form the resulting tea solution by a suitable process. Suitable processes for accomplishing this include ion exchange, reverse osmosis and precipitating divalent cations and thereafter filtering the precipitate from the solution, as well as combinations of the foregoing processes.

In accordance with another aspect of the method, the resulting solution having the low divalent cation concentration is treated to remove water to form a concentrated extract. The concentrated extract may be either in liquid or powder form. Typically, the extract would be subsequently used by adding water to the concentrated extract in a desired amount to form a final beverage which can then be suitably packaged as is known in the art.

The method of the invention may further include having green tea catechins present in the beverage in an amount of up to about 2,000 milligrams per liter.

In accordance with another aspect of the invention, the final beverage in accordance with the invention may be packaged by either cold fill, aseptic hot fill or other processing.

Thus, in accordance with the present invention, the invention allows for the production of stable tea beverages with high levels of tea, antioxidants, polyphenols, flavonoids and/or catechins. The resulting packaged beverage provides a stable tea material containing beverage having low turbidity, an attractive appearance that can be shelf stable for a long time, such as 180 days at 70° F.

Another important aspect of the present invention is that in addition to eliminating unacceptable or undesirable product appearance, the invention allows the addition of higher tea levels, higher levels of antioxidants, polyphenols, flavonoids and/or catechins while providing a uniform low turbidity beverage.

### DETAILED DESCRIPTION

### Definitions

As used herein, the term “tea material” or “tea materials” refers to green teas and/or black teas which includes materials or “tea solids” obtained from any of those teas. The teas may be freshly gathered tea leaves, fresh tea leaves that are dried after gathering, fresh tea leaves that have been treated before drying to inactivate enzymes, unfermented, partially fermented tea leaves and aqueous extracts of those leaves or portions thereof including tea plant stems.

As used herein, the term “catechins” refers to catechins derived from a green tea leaf, epicatechin (EC), epigallocatechin (EGC), epigallocatechin gallate (EGCG), gallocatechin gallate (GCG) and epicatechin gallate (ECG).

As used herein, the term “polyvalent cation” refers to one or more mineral cations that typically exist in solution in the form of positively charged cations within the charge of +2 or greater. Examples of polyvalent cations include calcium (Ca⁺²), magnesium (Mg⁺²), manganese (Mn⁺²), zinc (Zn⁺²), and iron (Fe⁺², Fe⁺³). As used herein, “ready-to-drink” (or RTE) are used interchangeably and refer to beverage compositions of the present invention that are at their recommended drink concentration and are ready for consumption without dilution.

As used herein, the term “stable” refers to packaged beverages that do not require refrigeration while stored at ambient temperatures for prolonged periods (such as more than 180 days).

As used herein, the term “solids” refers to the solid materials extracted from tea during brewing which can be soluble in water. The solids include amino acids, buffering salts, caffeine, carbohydrates, edible acids, flavenols, proteins and related materials.

In accordance with the present invention, a stable beverage composition is provided. The beverage composition is suitable for use as a ready-to-drink beverage. A beverage in accordance with the invention can be packaged in any suitable container known in the art and can be stored for extended periods of time without significant deleterious effects on stability, including appearance. Suitable bottles, cans and other containers are well known in the art and may be made of glass, plastic, aluminum and other materials.

A composition in accordance with the invention includes from about 100 to about 2,700 milligrams per liter by total weight of the beverage composition of a material selected from tea solids, tea polyphenols, tea flavonoids, tea catechins and combinations thereof. Those materials can be derived from any source as desired provided that the concentration of divalent cations in those materials is such that when combined with the other components of the beverage composition the resultant composition has a total divalent cation concentration in the range of from about 0 to about 100 milligrams per liter in the beverage composition. Such materials can be purified by removal of divalent cations by any suitable method known in the art. Such methods may include one or more of the following: ion exchange; reverse osmosis; precipitation of divalent cations followed by removal of the precipitate in a suitable manner such as by filtering, for example.

Preferably, the tea material that is utilized in the beverage composition of the invention contains less than about 450 milligrams divalent cations per 100 grams of the tea material.

The beverage composition may also include a chelating agent present in a sufficient amount to bind the divalent cations present in the beverage composition. Suitable chelating agents are known in the art and include, for example, ethylenediaminetetraacetic acid and salts thereof, polyphosphates and sodium or potassium citrates.

The water used in the beverage composition in accordance with the invention should have a hardness of from about 0 to about 50 milligrams per liter measured as CaCO₃. The total hardness in the beverage measured as CaCO₃ is preferably about 25 milligrams per liter.

Water may be treated by any manner known in the art to provide a hardness in the desired range. The water may be filtered, purified, deionized, demineralized, distilled, spring, mineral, artesian, softened, sparkling or carbonated water, for example.

In accordance with another aspect of the invention, the beverage composition may contain green tea catechins present in an amount of from about 10 to about 2,000 milligrams per liter. The beverage may also include green tea flavonoids present in an amount of from about 10 to about 2,000 milligrams per liter, green tea polyphenols present in an amount of from about 10 to about 2,700 milligrams per liter.

The green tea catechins, green tea flavonoids and green tea polyphenols should have less than 450 milligrams divalent cations per 100 grams of the catechin, flavonoid or polyphenol material. Such materials can be obtained from any suitable source including from green tea or from green tea extracts, for example. The tea materials must be treated to achieve a desired reduction of divalent cations so that when utilized in the beverage composition of the invention those materials contribute less than about 450 milligrams divalent cations per 100 grams of the added catechin, flavonoid and/or polyphenol material.

Preferably, the pH of the beverage composition will be adjusted by the addition of a suitable acid so that the pH is in the range of from about 2.5 to about 6.5. A preferred pH range is from about 3.0 to about 5.0. Any suitable acid can be used to adjust the pH of the beverage in accordance with the invention. Typical acids include citric, phosphoric, ascorbic, malic and combinations thereof.

Turbidity is an important aspect of a beverage. Low turbidity is usually desirable in a tea beverage and in a ready-to-drink beverage. Beverages in accordance with the present invention will typically have a turbidity of less than about 50 NTU and preferably less than about 40 NTU and most preferably less than 20 NTU, even after storage of the beverage composition in accordance with the invention after packaging (i.e. bottling) and storage 180 days at 70° F. the beverage. Typically, compositions in accordance with the invention containing about 900 mg/l of tea solids will have a turbidity of less than about 20 NTU, even after packaging (i.e. bottling) and storage for 180 days at 70° F.

Other components may be added to the beverage composition in accordance with the invention as desired, provided that the additive materials do not adversely affect the composition and have zero or a relatively low concentration of divalent cations whether as a salt or as a byproduct so that less than 100 milligrams per liter of divalent cations are present in the final beverage composition. Consequently, in order to not exceed that level it is important to carefully select formulating ingredients that have zero or a very low level of divalent cations. Consequently, it is important to utilize ingredients that have a high purity. Examples of additional ingredients that may be added in accordance with the invention include but are not limited to: sodium and/or potassium benzoate, potassium sorbate and/or other preservatives;

Sodium citrate, potassium citrate, polyphosphates and/or other buffering components;

Gums, pectins and/or other thickeners;

Citric acid, ascorbic acid, phosphoric acid, malic acid and/or other organic acids;

Caramel, natural and/or artificial colors;

Flavors, extracts and emulsions;

Nutritive sweeteners, natural sweeteners and/or artificial sweeteners.

In accordance with another aspect of the present invention, a method of making a color and turbidity stable beverage composition that contains tea solids is provided. The method includes brewing a tea solution having tea solids and thereafter removing divalent cations from the brewed tea solution to form a resulting solution having a divalent cation level of less than about 450 milligrams divalent cation per 100 grams of tea solids. Thereafter, a beverage is formed from the resulting solution, the beverage having a total of no more than from about 0 to about 100 milligrams per liter divalent cations and comprises from about 100 milligrams per liter to about 2,700 milligrams per liter tea solids.

In accordance with another aspect of the method, the tea solution is a green tea solution and the removing of the divalent cations comprises treating the tea solution to form the resulting tea solution by a suitable process. Suitable processes for accomplishing this include ion exchange, reverse osmosis and precipitating divalent cations and thereafter filtering the precipitate from the solution, as well as combinations of the foregoing processes.

In accordance with another aspect of the method, the resulting solution having the low divalent cation concentration is treated to remove water to form a concentrated extract. The concentrated extract may be either in liquid or powder form. Typically, the extract would be subsequently used by adding water to the concentrated extract in a desired amount to form a final beverage which can then be suitably packaged as is known in the art.

The method of the invention may further include having green tea catechins present in the beverage in an amount of up to about 2,000 milligrams per liter.

In accordance with another aspect of the invention, the final beverage in accordance with the invention may be packaged by either cold fill, aseptic hot fill or other processing.

Thus, in accordance with the present invention, the invention allows for the production of stable tea beverages with high levels of tea, antioxidants, polyphenols, flavonoids and/or catechins. The resulting packaged beverage provides a stable tea material containing beverage having low turbidity, an attractive appearance that can be shelf stable for a long time, such as 180 days at 70° F.

Another important aspect of the present invention is that in addition to eliminating unacceptable or undesirable product appearance, the invention allows the addition of higher tea levels, higher levels of antioxidants, polyphenols, flavonoids and/or catechins while providing a uniform low turbidity beverage.

Beverage compositions in accordance with the invention may be within the following formulas.

### EXAMPLE 1

### Examples of Non-Diet Beverages Include

| | Range % weight/weight |
|---|---|
| HFCS 55, sucrose, liquid sucrose and/or | 3.0 to 14.0% |
| medium invert sugar | |
| Sodium and/or potassium benzoate | 0 to 0.050% |
| Potassium sorbate | 0 to 0.050% |
| Sodium hexametaphosphate | 0 to 0.200% |
| Chelating agents (EDTA, polyphosphates | 0 to 0.010% |
| and/or citrates) | |
| Citric, phosphoric, ascorbic and/or malic acid | 0 to 0.500% |
| Tea solids (black and/or green - powder and/or | 0.01 to 0.500% |
| extract) | |
| Caramel | 0 to 0.100% |
| Pectin, gums and/or thickeners | 0 to 0.200% |
| Flavors | 0.01 to 0.500% |
| Water (max 50 mg/L hardness) | 75.0 to 99.0% |

### EXAMPLE 2

### Examples of Diet Beverages Include

| | Range % weight/weight |
|---|---|
| Sodium and/or potassium benzoate | 0 to 0.050% |
| Potassium sorbate | 0 to 0.050% |
| Sodium hexametaphosphate | 0 to 0.200% |
| Chelating agents (EDTA, polyphosphates | 0 to 0.010% |
| and/or citrates) | |
| Citric, phosphoric, ascorbic and/or malic acid | 0 to 0.500% |
| Tea solids (black and/or green - powder and/or | 0.01 to 0.500% |
| extract) | |
| Caramel | 0 to 0.100% |
| Pectin, gums and/or thickeners | 0 to 0.200% |
| Sodium citrate, potassium citrate, | 0 to 0.200% |
| polyphosphates an/or other buffers | |
| Flavors | 0.01 to 0.500% |
| Artificial sweeteners such as aspartame, | 0 to 0.500% |
| neotame acesulfame potassium | |
| and/or sucralose | |
| Water (max 50 mg/L hardness) | 75.0 to 99.5% |

While various embodiments of the present invention have been described, it is understood that various changes and modifications can be made without departing from the spirit and scope of the invention as defined by the appended claims. It is therefore intended that the appended claims cover all such changes, modifications and rearrangements that are within the scope of this invention.

What is claimed is:

1. A ready-to-drink color and turbidity stable beverage composition comprising:
from about 100 to 2,700 milligrams per liter by total weight of the beverage composition of a tea material selected from the group consisting of tea solids, tea polyphenols, tea flavonoids, tea catechins and combinations thereof;
optionally at least one sweetener selected from the group consisting of nutritive, natural, artificial and combinations thereof;
water;
a total of from about 0 to 100 milligrams per liter divalent cations in the beverage composition;
a turbidity of less than about 50 NTU.

2. The beverage of claim 1 wherein the tea material contain less than about 450 milligrams divalent cations per 100 grams of the tea material.

3. The beverage composition of claim 1 further comprising a chelating agent present in a sufficient amount to bind the divalent cations present in the beverage composition.

4. The beverage composition of claim 1 wherein the water in the beverage composition has a hardness in the range of from 0 to about 50 milligrams per liter measured as CaCO₃.

5. The beverage composition of claim 4 wherein the hardness is about 25 milligrams per liter measured as CaCO₃.

6. The beverage composition of claim 1 further comprising an antioxidant.

7. The beverage composition of claim 1 comprising green tea catechins present in an amount of from about 10 to about 2,000 milligrams per liter.

8. The beverage composition of claim 1 comprising green tea flavonoids present in an amount of from about 10 to about 2,000 milligrams per liter.

9. The beverage composition of claim 1 comprising green tea polyphenols present in an amount of from about 10 to about 2,700 milligrams per liter.

10. The beverage composition of claim 1 further comprising antioxidants present in an amount of from about 10 to about 3,000 milligrams per liter.

11. The beverage composition of claim 1 wherein the pH of the beverage composition is in the range of from about 3 to about 6.5.

12. The beverage composition of claim 1 wherein the beverage has a turbidity of less than about 40 NTU.

13. The beverage composition of claim 1 wherein the beverage has a turbidity of less than about 20 NTU after storage for 180 days at 70° F.

14. The beverage composition of claim 1 wherein the tea solids comprise black tea solids.

15. The beverage composition of claim 1 wherein the tea solids comprise green tea solids.

16. The beverage of claim 15 wherein the green tea solids comprise less than 450 milligrams divalent cations per 100 grams of said green tea solids.

17. A method of making a color and turbidity stable beverage composition comprising:
brewing a tea solution having tea solids;
removing divalent cations from the brewed tea solution to form a resulting solution having a divalent cation level of less than about 450 milligrams divalent cations per 100 grams of tea solids;
forming a beverage from the resulting solution, the beverage having a total of no more than from about 0 to about 100 milligrams per liter divalent cations and comprising from about 100 milligrams per liter to about 2,700 milligrams per liter tea solids.

18. The method of claim 17 wherein the tea solution is a green tea solution and said removing divalent cations comprises treating the tea solution to form the resulting solution by a process selected form the group consisting of: (a) ion exchange; (b) reverse osmosis; and (c) precipitating divalent cations and filtering the precipitate from the tea solution.

19. The method of claim 18 further comprising removing water from the resulting solution to form a concentrated extract and subsequently adding water to the concentrated extract to form the beverage.

20. The method of claim 17 wherein green tea catechins are present in the beverage in an amount of up to about 2,000 milligrams per liter.
